(19) United States
(12) Patent Application Publication
(10) Pub. No.: US 2008/0034004 A1
(43) Pub. Date: Feb. 7, 2008

(54) System for electronic backup

(76) Inventors: Pavel Cisler, Los Gatos, CA (US); Kevin Tiene, Cupertino, CA (US); Steve Ko, San Francisco, CA (US); Robert Ulrich, San Jose, CA (US)

Correspondence Address: FISH & RICHARDSON P.C., PO BOX 1022, MINNEAPOLIS, MN, 55440-1022, US

(21) Appl. No.: 11/499,848

(22) Filed: Aug. 4, 2006

(51) Int. Cl. G06F 17/30

(52) U.S. Cl. 707/200

(57) ABSTRACT

Systems and methods are provided for storing backup data. In one implementation, a method is provided. An external device coupled to a computer system for use in storing backup data is automatically identified. Backup data for the system is stored on the identified storage device. The stored backup data includes a file system hierarchy. The stored backup data is managed. In other implementations, the backup data can be managed including selecting a device to be used for storing backup data and archive management of the stored data.

### RELATED APPLICATIONS

This application is generally related to the following jointly owned and co-pending patent applications, each incorporated herein by reference in its entirety:
U.S. patent application No. ______, for “Managing Backup of Content,” filed Aug. 4, 2006;
U.S. patent application No. ______, for “User Interface for Backup Management,” filed Aug. 4, 2006;
U.S. patent application No. ______, for “Navigation of Electronic Backups,” filed Aug. 4, 2006;
U.S. patent application No. ______, for “Architecture for Back Up and/or Recovery of Electronic Data,” filed Aug. 4, 2006;
U.S. patent application No. ______, for “Searching a Backup Archive,” filed Aug. 4, 2006;
U.S. patent application No. ______, for “Application-Based Backup-Restore of Electronic Information,” filed Aug. 4, 2006;
U.S. patent application No. ______, for “System for Multi-Device Electronic Backup,” filed Aug. 4, 2006;
U.S. patent application No. ______, for “Consistent Back Up of Electronic Information,” filed Aug. 4, 2006;
U.S. patent application No. ______, for “Restoring Electronic Information,” filed Aug. 4, 2006;
U.S. patent application No. ______, for “Links to a Common Item in a Data Structure,” filed Aug. 4, 2006;
U.S. patent application No. ______, for “Event Notification Management,” filed Aug. 4, 2006;
U.S. patent application No. ______, for “Conflict Resolution in Recovery of Electronic Data,” filed Aug. 4, 2006.

### TECHNICAL FIELD

The disclosed implementations relate generally to storing and restoring data.

### BACKGROUND

A hallmark of modern graphical user interfaces is that they allow a large number of graphical objects or items to be displayed on a display screen at the same time. Leading personal computer operating systems, such as Apple Mac OS®, provide user interfaces in which a number of windows can be displayed, overlapped, resized, moved, configured, and reformatted according to the needs of the user or application. Taskbars, menus, virtual buttons and other user interface elements provide mechanisms for accessing and activating windows even when they are hidden behind other windows.

With the sophisticated tools available, users are encouraged not only to create and save a multitude of items in their computers, but to revise or otherwise improve on them over time. For example, a user can work with a certain file and thereafter save its current version on a storage device. The next day, however, the user could have had second thoughts about the revisions, or could have come up with new ideas, and therefore opens the file again.

The revision process is usually straightforward if the user wants to add more material to the file or make changes to what is there. But it is typically more difficult for a user who has changed his/her mind about changes that were previously made and wants the file back as it was once before. Application programs for word processing typically let the user “undo” previous edits of a text, at least up to a predefined number of past revisions. The undo feature also usually is configured so that the previously made revisions must be undone in reverse chronological order; that is, the user must first undo the most recently made edit, then the second-most recent one, and so on. If the user saves and closes the document and thereafter opens it again, it may or may not be possible to automatically undo any previous edits.

### SUMMARY

Systems and methods are provided for storing backup data. One or more external devices can be used to store the backup information. A backup system can automatically detect external storage devices and provide an interface for user designation of particular storage devices. Additional backup options can include alternating backup storage between two or more storage devices for redundancy of backup. Also, backup data can be stored on a remote network device such as a remote server instead of local storage devices.

In general, in one aspect, a method is provided. An external device coupled to a computer system for use in storing backup data is automatically identified. Backup data for the system is stored on the identified storage device. The stored backup data includes a file system hierarchy. The stored backup data is managed.

Implementations of the method can include one or more of the following features. Identifying a storage device can include receiving a user input selecting a particular storage device. The method can further include storing incremental backup data on the storage device, the incremental backup data including data representing changes from the stored backup data. Storing backup data can include uploading data to server storage device. Managing the stored backup data can include removing previously stored backup data. Removing previously stored backup data can include removing backup data according to a date on which the previously stored backup data was stored. Removing previously stored backup data can include removing backup data according to a threshold capacity of the external storage device. Removing previously stored backup data can include using one or more criteria to determine which data of the stored backup data to delete, where the criteria maximize storage and minimize data loss.

In general, in one aspect, a method is provided. A first external storage device coupled to a computer system for use in storing backup data is identified. A second external storage device coupled to the computer system for use in storing backup data is identified. Backup data for the system is stored to one or more of the first and second external storage devices, the stored backup data including a file system hierarchy. The stored backup data is managed.

Implementations of the method can include one or more of the following features. Storing backup data for the system can include storing backup data alternatively between the first external storage device and the second external storage device. The method can further include automatically switching from the first external storage device to the second external storage device when a threshold capacity of the first external storage device is reached. The method can further include storing identical backup data on the first external storage device and the second external storage device.

In general, in one aspect, a method is provided. One or more criteria are defined for capturing a state of a view of a user interface. The state of the view is captured in accordance with the criteria. A captured view is stored on an external storage device. A prompt is received to suspend presentation of a current view and present the captured view. The captured view is retrieved from the external storage device. The captured view is reinstated into the current view of the user interface.

Particular embodiments of the subject matter described in this specification can be implemented to realize one or more of the following advantages. Backup data can be stored to more than one external storage device in order to provide redundant protection of data. Archive management functions can maximize the value of the backup data stored on each storage device.

The details of the various aspects of the subject matter described in this specification are set forth in the accompanying drawings and the description below. Other features, aspects, and advantages of the invention will become apparent from the description, the drawings, and the claims.

### BRIEF DESCRIPTION OF THE DRAWINGS

FIG. 1 is a block diagram of an example of an architecture for modifying a user interface view in a display environment.

FIG. 2 is a block diagram of an example of an architecture for backing up and restoring application files.

FIG. 3 shows an example of a time machine settings dialog.

FIG. 4 shows an example of a time machine settings dialog for setting backup storage device options.

FIG. 5 shows an example of a time machine settings dialog over which a pop-up window for a-particular storage device is displayed.

FIG. 6 shows an example of a time machine settings dialog for setting archive management options.

FIG. 7 shows an example of a time machine settings dialog and a pop-up window for accessing the settings options of particular archive management technique.

FIG. 8 is a screen shot depicting an example of a time machine user interface generated by a time machine engine.

FIG. 9 is a screen shot depicting another example of a time machine user interface.

FIG. 10 is a flow diagram of a method illustrating an archive management scenario.

### DETAILED DESCRIPTION

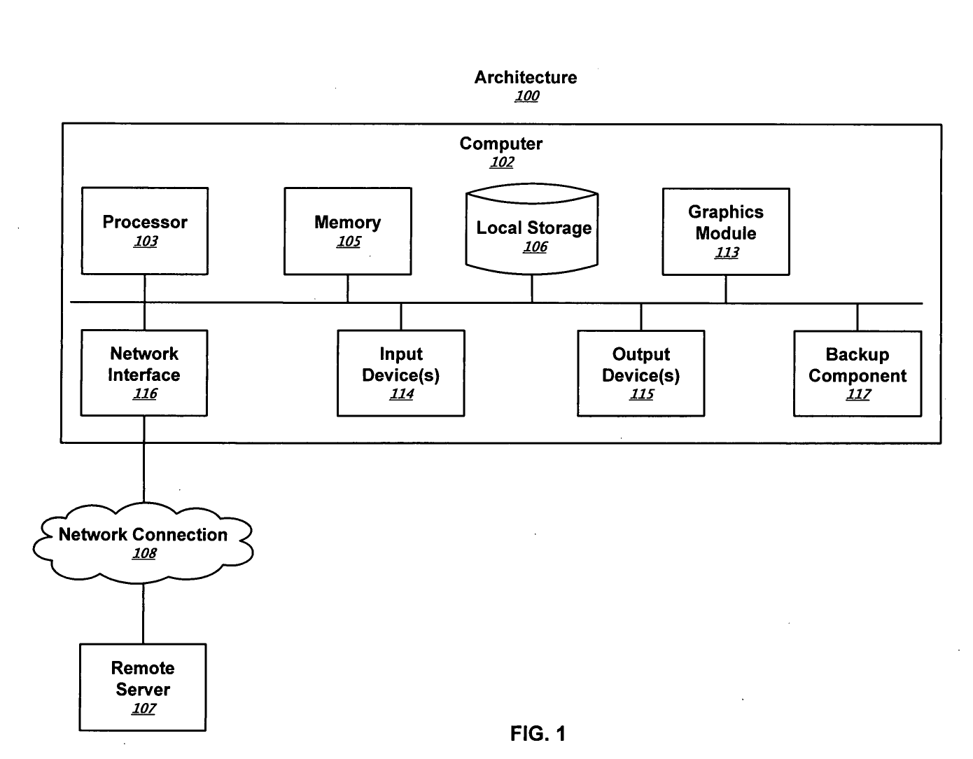

FIG. 1 is a block diagram of an architecture 100 for capturing versions of an interface view and managing an archive of such backups, for example to facilitate user-initiated restoration based on any of them. As used herein, a view refers to an item, element or other content, capable of being stored and/or retrieved in an interface, that can be subjected to a backup operation by the backup component 117. For example, a user interface view can contain any number of icons, files, folders, application state information, and/or machine state information, etc. The architecture 100 includes a personal computer 102 communicatively coupled to a remote server 107 via a network interface 116 and a network 108 (e.g., local area network, wireless network, Internet, intranet, etc.). The computer 102 generally includes a processor 103, memory 105, one or more input devices 114 (e.g., keyboard, mouse, etc.) and one or more output devices 115 (e.g., a display device). A user interacts with the architecture 100 via the input and output devices 114, 115. Architecture 100 as disclosed includes various hardware elements. Architecture 100 can include hardware, software, and combinations of the two.

The computer 102 also includes a local storage device 106 and a graphics module 113 (e.g., graphics card) for storing information and generating graphical objects, respectively. The local storage device 106 can be a computer-readable medium. The term “computer-readable medium” refers to any medium that includes data and/or participates in providing instructions to a processor for execution, including without limitation, non-volatile media (e.g., optical or magnetic disks), volatile media (e.g., memory) and transmission media. Transmission media includes, without limitation, coaxial cables, copper wire, fiber optics, and computer buses. Transmission media can also take the form of acoustic, light or radio frequency waves.

While modifications of a user interface view are described herein with respect to a personal computer 102, it should be apparent that the disclosed implementations can be incorporated in, or integrated with, any electronic device that has a user interface, including without limitation, portable and desktop computers, servers, electronics, media players, game devices, mobile phones, email devices, personal digital assistants (PDAs), embedded devices, televisions, other consumer electronic devices, etc.

Systems and methods are provided for searching stored contents that correspond to earlier versions of system information, application information or system, application, or user interface state. Systems and methods are also provided for modifying an interface view (e.g., a user interface view). The systems and methods can be stand-alone or otherwise integrated into a more comprehensive application. In the materials presented below, an integrated system and method for modifying a user interface view is disclosed.

Though discussion is made with reference to modifying a user interface view, those of ordinary skill will recognize that such a view can be based on various data structures, files, processes, and other aspects of information management. It follows that modification to file structures, data and the like is also contemplated in order to achieve the modification to the user interface view. In other words, while the restoration of the user interface view from one state to another is the most apparent change from the user's perspective, this is accomplished through the corresponding changes in the underlying system content.

One of ordinary skill in the art will recognize that the engines, methods, processes and the like that are described can themselves be an individual process or application, part of an operating system, a plug-in, an application, or the like. In one implementation, the system and methods can be implemented as one or more plug-ins that are installed and run on the personal computer 102. The plug-ins are configured to interact with an operating system (e.g., MAC OS® X, WINDOWS XP, LINUX, etc.) and to perform the various functions, as described with respect to the Figures. A system and method for modifying a user interface view can also be implemented as one or more software applications running on the computer 102. Such a system and method can be characterized as a framework or model that can be implemented on various platforms and/or networks (e.g., client/server networks, wireless networks, stand-alone computers, portable electronic devices, mobile phones, etc.), and/or embedded or bundled with one or more software applications (e.g., email, media player, browser, etc.).The computer 102 includes the backup component 117 that allows for the storage of versions of the computer's files or other items, for example within the local storage 106 or in an external storage repository. In one implementation, the backup component 117 also allows a user to select any of the stored versions and use it to initiate a restoration of that version in the computer 102.

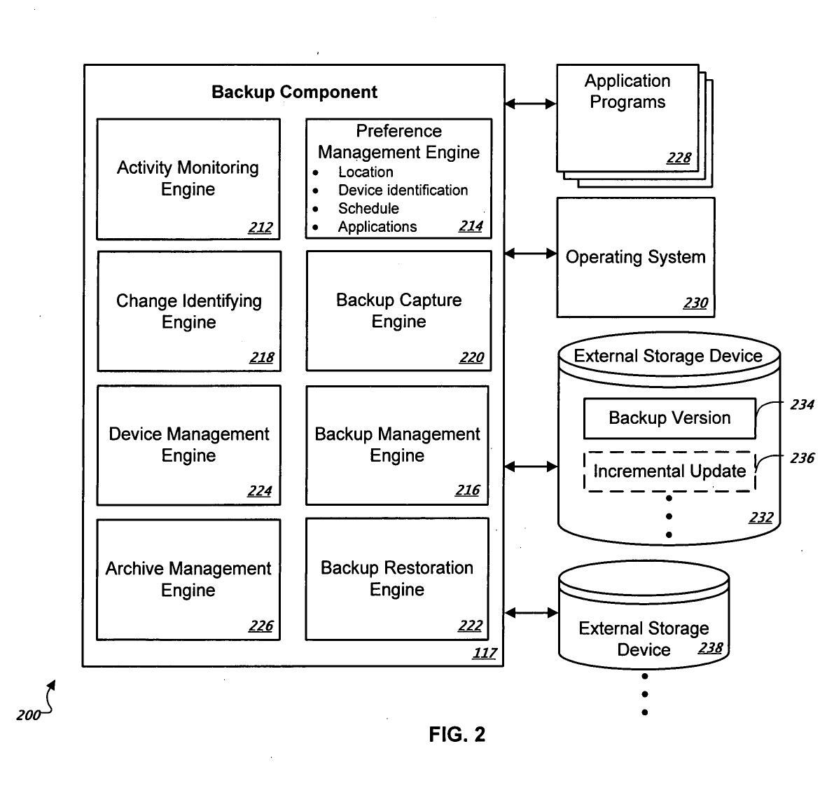

FIG. 2 is a block diagram of an exemplary architecture 200 for enabling the back up and restoration of data (e.g., application files, application data, settings, parameters or the like), such as those associated with a set of application programs 228. Backup component 117 provides back up and restoration capability for the system. Many different items or elements can be the subject of a backup operation in the system. For example, folders, files, items, information portions, directories, images, system or application parameters, playlists, e-mail, inbox, application data, address book, preferences, a state of an application or state of the system, preferences (e.g., user or system preferences), and the like all can be candidates for archiving. Other types are also possible. In this example, the backup component 117 includes two external storage devices, device 232 and device 238. Versions can be stored on either of them. Any number of local and/or external storage devices can be used by the backup component 117 for storing versions.

In one implementation, the backup component 117 runs as a background task on an operating system 230, that is not visible to the user. The backup component 117 can be capable of running across multiple user accounts.

The backup component 117 includes an activity monitoring engine 212. In one implementation, the activity monitoring engine 212 monitors for changes within an application view (e.g. files) that are targeted for a backup operation. A change can also include the addition of new files or data or the deletion of the same.

In one implementation, the activity monitoring engine 212 is capable of discerning between a substantive change (e.g. the text within a document has been modified) and a non-substantive change (e.g. the play count within an iTunes playlist has been updated, or several changes cancel each other out) through its interaction with the application programs 228. The activity monitoring engine 212 can, for example, create a list of modified elements to be used when a backup event is eventually triggered. In one implementation, the activity monitoring engine 212 can monitor the system for periods of inactivity. The activity monitoring engine 212 can then trigger a backup event during a period of time in which the backup operation will not cause a system slowdown for an active user.

A preference management engine 214 specifies some operating parameters of the backup component 117. In one implementation, preference management engine 214 contains user-specified and/or system default application parameters for the backup component 117. These can include settings for the details of capturing and storing the earlier versions. For example, the preference management engine 214 can determine the frequency of a backup capture, the storage location for the backup versions, the types of files, data, or other items that are eligible for backup capture, and the events which trigger a backup capture (periodic or event-driven, etc.).

In one implementation, the preference management engine 214 can detect that a new storage device is being added to the system and prompt the user whether it should be included as a backup repository. Files and other items can be scheduled for a backup operation due to location (e.g. everything on the C: drive and within D:/photos), a correlation with specific applications (e.g. all pictures, music, e-mail, address book and system settings), or a combination of strategies. Different types of items can be scheduled to be stored on different devices or on different segments of a storage device during a backup operation. In one implementation, the backup component 117 stores the versions in a format corresponding to a file system structure.

A backup management engine 216 coordinates the collection, storage, and retrieval of view versions performed by the backup component 117. For example, the backup management engine 216 can trigger the activity monitoring engine 212 to watch for activities that satisfy a requirement specified in the preference management engine 214.

A change identifying engine 218 locates specific views or other items within to determine if they have changed. The change identifying engine 218 can be capable of discerning a substantive change from a non-substantive change, similar to the example described above for the activity monitoring engine 212. In one implementation, the change identifying engine 218 traverses a target set of files, data, or other items, comparing a previous version to the current version to determine whether or not a modification has occurred.

A backup capture engine 220 locates files, data, or other items that are to be backed up. The backup capture engine 220 can invoke the activity monitoring engine 212 and/or the change identifying engine 218, for example, to generate a capture list. The backup capture engine 220 can then store copies of these elements in one or more targeted storage repositories. The backup capture engine 220 can track multiple version copies of each item included in the backup repository.

The backup component 117 includes a backup restoration engine 222 to restore previous views (e.g. versions of files, data, or other items). In one implementation, the backup restoration engine 222 provides an user interface (e.g., a graphical user interface) where a user can select the item(s) to be restored.

A device management engine 224 handles the addition and removal of individual storage devices to be used for archiving views. In one implementation, the preference management engine 214 obtains user settings regarding the identification of individual storage devices for use in archiving. These settings could include, but are not limited to, particular segments of individual devices to use, a threshold capacity which can be filled with archive data, and individual applications to archive to each device. The device management engine 224 records the storage device settings obtained by the preference management engine and uses them to monitor storage device activity. In one implementation, the device management engine 224 can alert the user when a new device has been added to the system. In one implementation, the device management engine 224 can alert the user when an archive-enabled device has been removed from the system. In yet another implementation, the device management engine 224 can alert the user when an archive-enabled device is nearing its threshold storage capacity setting.

An archive management engine 226 tracks where archived views are being stored. In one implementation, the archive management engine 226 obtains user options from the preference management engine. Such settings can include, but are not limited to, methods to be used to remove older or otherwise unnecessary archived views. These settings can establish a criteria for archived view deletion, for instance in the event of storage capacity being reached or on a regular basis. In one implementation, the archive management engine 226 alerts the user when archives are missing because a device has gone offline. In another implementation, the archive management engine 226 bars a user from viewing another user's archive data due to system permissions settings.

In this example, a first external storage device 232 is being used by the backup component 117 for archiving. The first device 232 contains an initial backup version 234, which is the first archived view created within this device for a particular item. The first device 232 also contains an incremental update 236. In one implementation, the incremental update 236 contains links back to data stored within initial backup 234, such that only one copy of an unchanged piece of data is retained. In this manner, links can also exist between incremental updates. Each incremental update can then contain a copy of each new or changed data item plus a link back to a previously stored copy of each unchanged data item. Any number of incremental updates can exist. If the user changes the scope of data that is being backed up from one incremental update period to another so that the scope of data now includes new data areas, a portion of an incremental update can be considered similar to an initial backup version. Other archive management techniques could be used.

Any number of storage devices can be used by the backup component 117. A second external storage device 238 is, in one implementation, used as an overflow repository in the event that the first device 232 reaches capacity. In another implementation, different storage devices contain the backup version and incremental updates of data belonging to different applications or to different users on the system. As another example, two or more storage devices can be responsible for backing up contents from separate applications in the system.

The archived copies can be compressed and/or encrypted. An example of a compression technique is the ZIP file format for data compression and archiving. An example of an encryption technique is the RSA algorithm for public key encryption. Other compression techniques or encryption techniques could be used.

In one implementation, if multiple users make use of the time machine backup component 117 on a single system, each user can select to keep separate archives. Access to an individual user's archives can be password protected or otherwise held in a secure manner. In one implementation, the archive storage structure mimics a typical file system structure, such that the archived versions can be perused using a standard file system viewing utility.

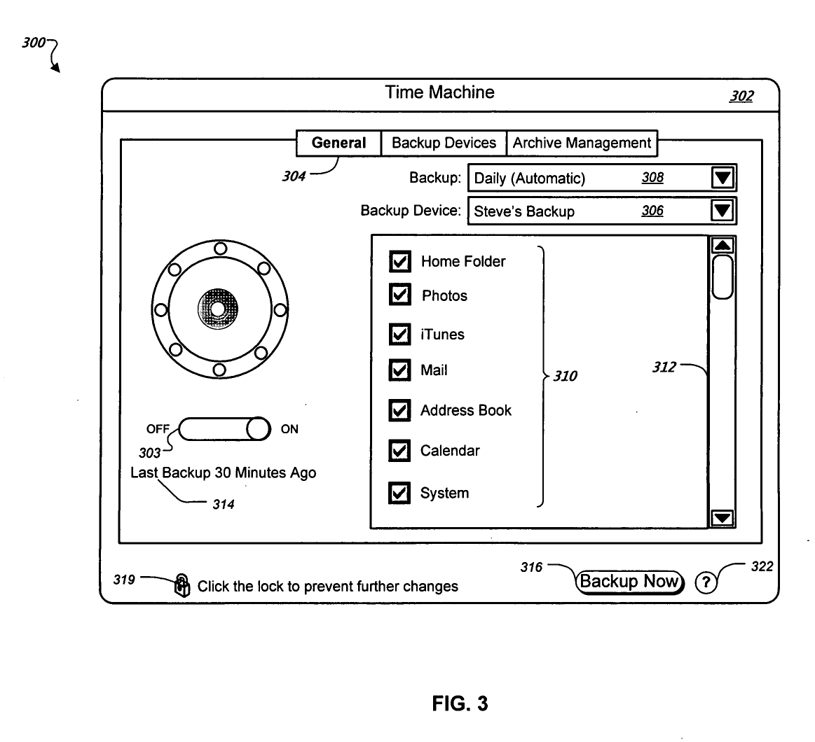

FIG. 3 shows a screen shot 300 depicting an example of a time machine settings dialog 302. In one implementation, the dialog 302 is generated by the preference management engine 214 (FIG. 2). A general settings tab 304 is selected. A user can select a device name within a drop-down menu 306 to establish backup location or device (e.g., Steve's Backup shown in FIG. 3). A drop-down menu 308 can be used to set the frequency of making backups (e.g. every day, every week, every other week, or every month, etc.). In another implementation, a time of day or other granularity setting could be available. Such a setting would allow the user to request that the utility run during a typically inactive period, such as overnight. In one implementation, an event-driven trigger can be specified, such as to have the backup utility run upon system start-up. In another example of an event-driven trigger, the time machine could be set to back up when there has been activity relating to the item that is to be backed up. In one implementation, the backup operation can be set to run in periods of inactivity when there is less user demand on system performance.

A user can select from a set of applications 310 which type(s) of data is eligible for a backup. The applications list could contain specific products (e.g. iTunes) and/or general categories (e.g. photos, address book, e-mail inbox). In one implementation, each application name is individually selectable. For example, within an internet browser application, the user could opt to set the bookmarks and personal settings to be backed up but not the history or cookies. One implementation could allow a user to select specific disk drives, folders, and/or files for a backup. A scroll bar 312 allows the user to view additional applications or candidates which do not fit within the viewing window. In one implementation, all data is included in the backup unless specifically excluded by the user.

A message block 314 alerts the user as to the date and time of the last backup event. In one implementation, this information is obtained from the backup capture engine 220 (FIG. 2). The user can select a slide bar control 303 to switch the backup operations on or off. A user can select a backup now button 316 to trigger a backup event. In one implementation, the backup now button 316 calls the backup capture engine 220 (FIG. 2) to initiate a capture event using-the settings provided within the time machine settings dialog 302.

If a lock icon 319 is selected, the time machine engine backup configuration is essentially locked into place until the icon 319 is selected again. For example, selecting the lock icon 319 in the settings dialog 302 can ensure that daily (automatic) backup operations are performed using the selected backup device (e.g., Steve's Backup) as the storage medium until the lock icon 319 is again selected, thus unlocking the current backup configuration.

A user can select a help button 322 to open a help dialog regarding the time machine engine. The help dialog can be presented within the time machine settings dialog 302 or in a separate pop-up window, for example. In another implementation, a mouse over of individual controls within the time machine settings dialog 302 can provide the user with a brief description of that control's functionality.

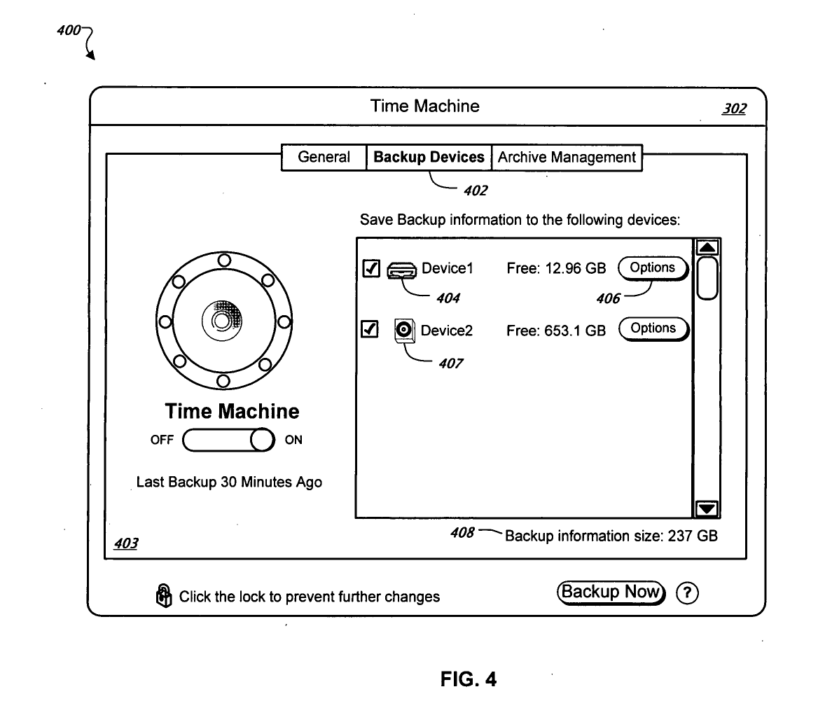

FIG. 4 shows a screen shot 400 depicting an example of the time machine settings dialog 302 in which a backup devices tab 402 is selected. A backup devices view 403 allows the user to select one or more repositories for storing archived items. In this example, a first device 404 and a second device 407 are available for use. A user can select an options button 406 associated with the first device 404 to view a settings dialog for this device. In one implementation, selection of the options button 406 triggers the display of another pop-up window. The icons associated with the first device 404 and the second device 407 could be indicative of the type of the device. For example, the icon associated with the first device 404 is a graphic of an optical device (e.g., a recordable CD drive). An information field 408 informs the user of the present size of the archived information. In this example, the backup information distributed between the first device 404 and the second device 407 is taking up 237 gigabytes of space.

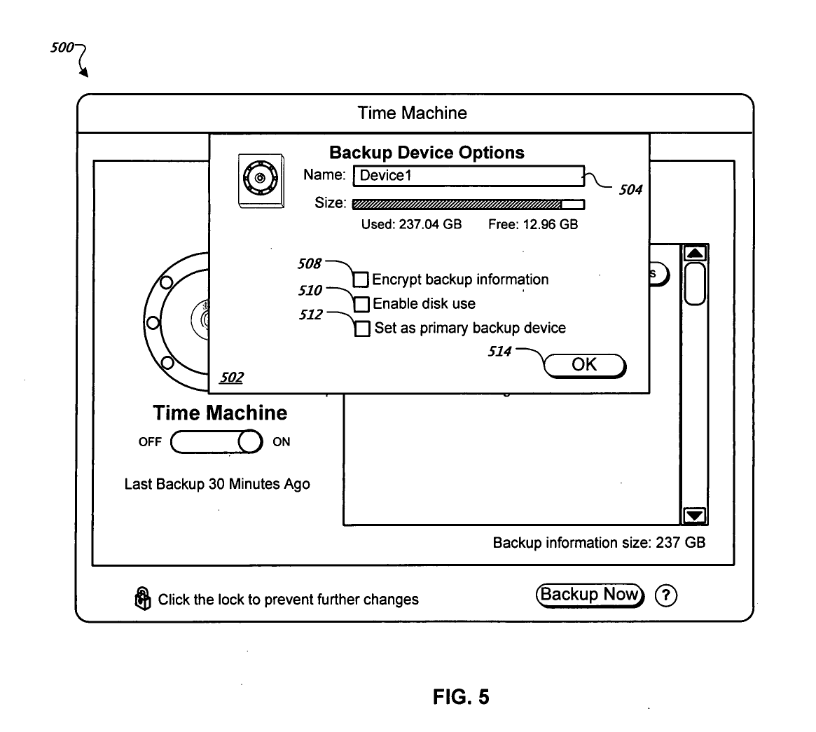

For the next example, the user selects the options button 406 (FIG. 4). As shown in FIG. 5, a screen shot 500 contains a pop-up window 502 overlaying the time machine settings dialog 302. The pop-up window 502 displays options relating to the first device 404. An information field 504 contains the storage device name, in this example “Device1”. A bar graph 506 illustrates the amount of free space available on the first device 404. According to the text beneath the bar graph, 237.04 gigabytes of memory has been used, and 12.96 gigabytes of memory is free on the first device 404.

A user can select a checkbox 508 to have the corresponding backup information encrypted. For example, in one implementation, this causes the existing archives within the associated backup device to be placed in an encrypted format. In another implementation, only the archives generated after the time of selecting the checkbox 508 will be generated in an encrypted format. In one implementation, the backup capture engine 220 (FIG. 2) creates the encrypted copies for the archives. A user can select a checkbox 510 to enable the first device 404 for disk use. For example, this could involve synchronizing the first device with the system. A user can further select a checkbox 512 to set this device as the primary backup device. For example, setting the first device 404 as the primary device defines that the archived views should be stored on the first device 404 until the first device 404 is full or the backup component 117 cannot find the first device 404, for instance because the first device 404 is no longer connected.

In one implementation, the information field 504 can be user-editable to define the storage location in greater detail. For example, a particular segment or segments of a backup device could be selected rather than the entire device. A user can select an OK button 514 to close the popup window 502 and return to the time machine settings dialog 302.

In one implementation, the storage device can be network based. For example, the user can store archive data on a remote server (e.g., using a media access control (MAC) address to a storage location). Alternatively, the user can store archive data on a local storage network such as a storage area network (SAN). In one implementation, the remote network storage is a primary storage location for archive data. In an alternative implementation, the remote network storage is an alternative storage location for archive data. For example, if the user's primary storage location is not available (e.g., a local storage device such as a Firewire drive), then the archive can be stored on the remote network storage.

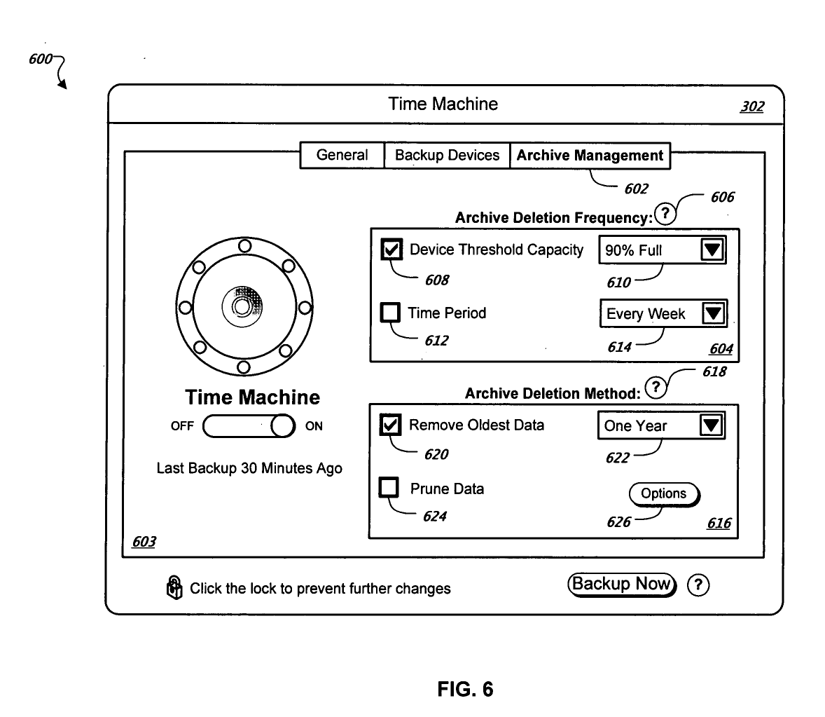

FIG. 6 shows a screen shot 600 depicting an example of the time machine settings dialog 302 in which an archive management tab 602 is selected. An archive management view 603 is presented within the time machine settings dialog 302. Archive management helps the user control the amount of information contained within the archives, thereby managing storage capacity requirements. A settings subsection 604 allows the user to control archive deletion frequency. The settings subsection 604 contains a first checkbox 608 with an associated drop-down menu 610. The first checkbox 608 relates to the device threshold capacity. Selection of the first checkbox 608 allows the user to choose a storage device capacity at which archive deletion should occur to clear space. For example, the user can opt for archive deletion to occur when the storage device is 90% full by setting the drop-down menu 610 to the 90% full label. In one implementation, this threshold setting pertains to the cumulative capacity of all storage devices activated as archive devices. In another implementation, archive management settings could be device-specific, user-specific, or application-specific. In one implementation, the user is notified when archive storage is nearing threshold capacity.

A second checkbox 612 provides that the user can choose for information from the archive to be deleted on a periodic basis. An associated drop-down menu 614 can be used to set the specific time period. The second checkbox 612 allows the user to set a time period for archive removal, e.g., the current setting of “Every week”. Both the first checkbox 608 and the second checkbox 612 can be activated concurrently such that, for example, deletion of archive data occurs every other week and unscheduled cleanups can be performed if the device reaches threshold capacity between the periodically scheduled removals. In one implementation, archive deletion can be triggered to occur at times of low system activity.

A help icon 606 provides the user with a description of the archive deletion frequency settings options. In one implementation, activation of the help icon 606 causes a pop-up window to appear. Alternatively, the help information could be provided within the confines of the settings subsection 604 or the archive management view 603, for example.

The user can access archive deletion method options through the settings subsection 616. A first checkbox 620 relates to removing the oldest data stored by the backup component 117. An associated drop-down menu 622 allows the user to specify the age at which archived data is eligible for deletion. For example, a user can opt to allow the deletion of archived data which is over one year old.

Sometimes, it is not prudent to remove data based on age alone. This could be the case when the archived data is comprised of a collection of both relatively static data and very dynamic data. For example, a relatively static data is one that is modified only infrequently; a relatively dynamic data is one that changes value often. If, in such a scenario, the archive deletion method is set for removal at one year old, archives containing copies of information which have not changed for over a year are deleted from the system. Meanwhile, a large number of versions of a very dynamic piece of data could be using a large amount of archive storage space. A second checkbox 624 allows the user to instead direct the archive management engine 226 to prune data from the archive storage. Pruning allows for selectively deleting one or more of the stored backup versions. For example, assume that incremental archives are created on a daily basis. Once a set of incremental archives thus created reaches a month old, selected ones of the incremental updates can be deleted, for example such that only weekly incremental updates remain. A help icon 618 provides the user with a detailed description of the archive deletion method settings.

An options button 626 provides that the user can enter additional settings regarding the manner of pruning the stored incremental updates. In one implementation, the archive management engine 226 uses a default formula rather than the user entering the options button 626. The default formula could be based, for example, upon the frequency at which incremental archived views are created.

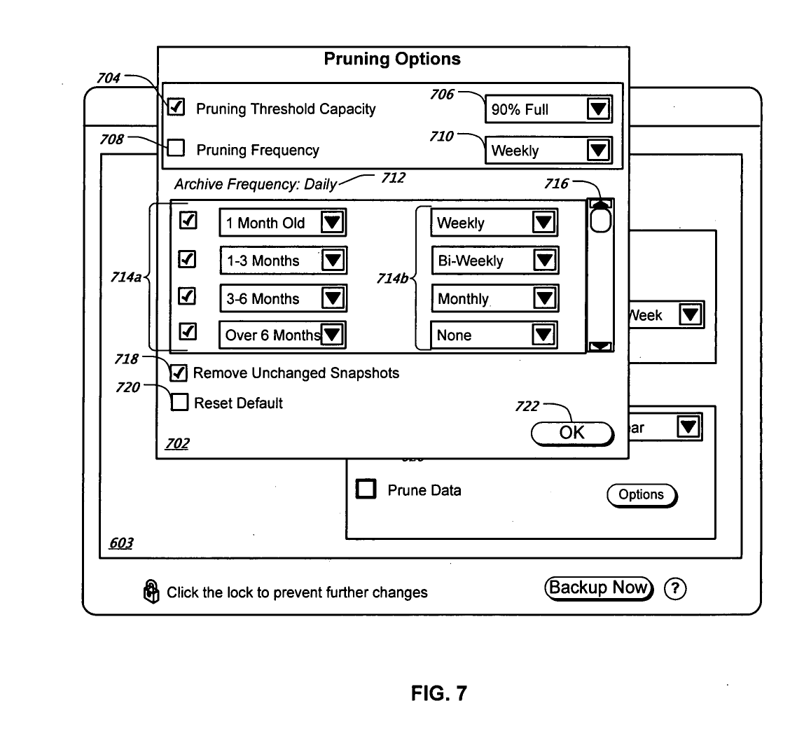

Here, the user selects the options button 626 (FIG. 6). As shown in FIG. 7, a screen shot 700 contains a pop-up window 702 overlaying the time machine settings dialog 302. The user can select a first checkbox 704 to set a threshold storage device capacity at which pruning should take place. An associated drop-down menu 706 allows the user to determine a specific threshold capacity, for instance the capacity when the storage device is 90% full. In one implementation, the cumulative storage capacity of all devices presently utilized for archival storage is taken into account in this threshold calculation. In one implementation, the user is alerted when storage is nearing the threshold capacity level. In one implementation, one or more of the checkboxes 704 and 706 and the associated menu could override a selection in a corresponding one of the checkboxes 608 or 612 (FIG. 6).

A second checkbox 708, when selected, sets the pruning frequency to a specific timeframe, as selected via a drop-down menu 710. For example, pruning can be scheduled to occur on a weekly basis. Both the threshold capacity and frequency settings can be used in conjunction, such that the pruning operation will occur on a fixed schedule as long as the storage capacity of the device(s) has not reached the set threshold level.

A message bar 712 alerts the user to the archived view frequency presently set for this system (e.g., on a specific device, for a particular application, for a particular user's data, etc). The user can take this information into consideration when adjusting the pruning settings. For example, less pruning could be needed for contents that are not archived very often. A set of drop-down menus 714a allow the user to choose an age range of archived contents that are to be pruned. An associated set of drop-down menus 714b allow the user to specify the frequency of archives to retain for each age range selected. For example, a user here adjusts the pruning frequency so that for archive contents that are one month old, only one backup version per week should be kept. For archive contents that have aged between 1-3 months, only a biweekly version will be retained. Contents 2-6 months old will be pruned to a monthly backup version. Contents that are over six months old are here set to be deleted; that is, no archive versions are to be kept for such contents. In this manner, the pruning functionality can be set up to work similarly to the deletion functionality which removes the oldest data, to name one example.

Any number of age range categories can be established. A scroll bar 716 allows the user access to more adjustment settings if the user desires a greater number of pruning categories than fit within the pop-up window 702. A checkbox 718 allows the user to specify that pruning should, when applicable, delete those backup versions that contain no differences compared to a previous (or later) version. Such a previous version can be the current version of the content or the next one following the deleted version, to name examples. For example, for a system having a daily backup operation, a number of consecutive backups can be unchanged from the previous backup. These unchanged backup versions can be deleted such that only backup data indicating a change from a previous backup is retained. For example, this can be done in circumstances where no copies of data elements exist in the archived view, only links to copies within other archived views.

When the pop-up window 702 is first opened, in one implementation, a default pruning formula is already entered in the message box 712. In this manner, the user can keep the default or manually adjust to suit specific needs. If the user is displeased with his or her adjustments, a checkbox 720 allows the user to reset the default pruning settings. Once the user is content with the pruning settings, selection of an OK button 722 closes the pop-up window 702 and returns the user to the time machine settings dialog 302.

As noted above, the management of backup versions can be handled by the backup component 117 (FIG. 1). That component can generate a time machine interface with which the user can control the restoration of selected content and see the results thereof. Such an interface can be generated by the backup restoration engine 222 (FIG. 2). There will now be described an example of how such an interface can reflect a pruning operation.

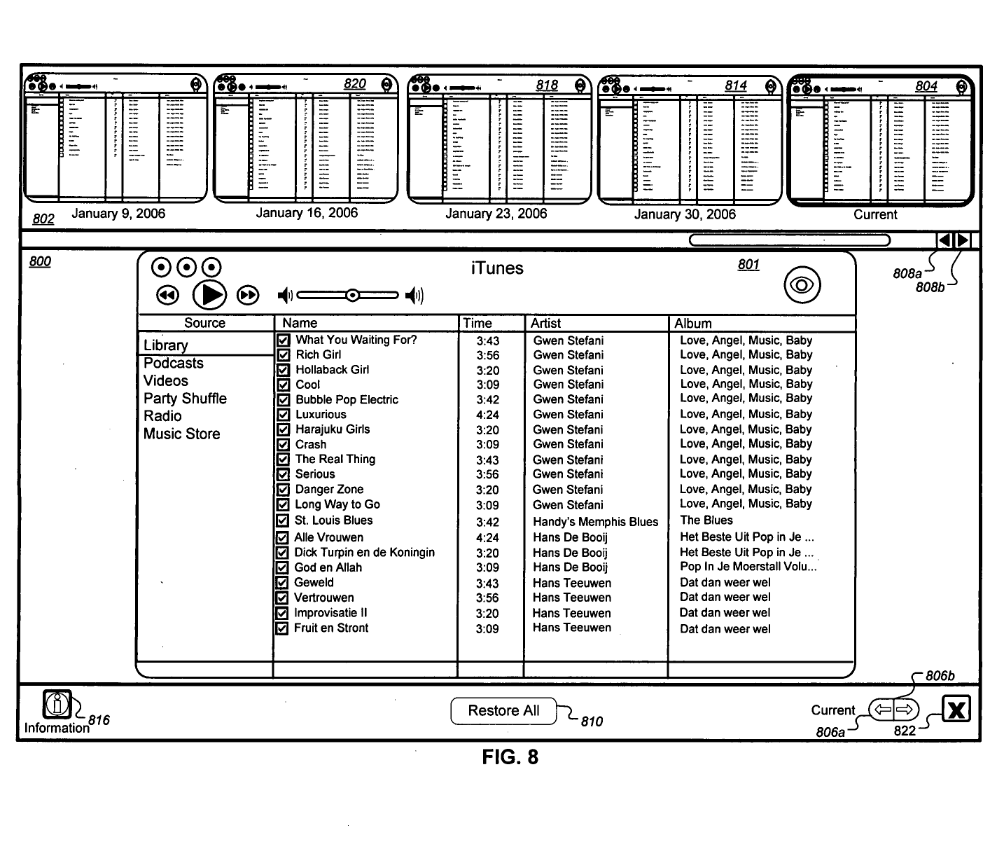

FIG. 8 is a screen shot depicting an example of an initial state for a time machine user interface 800 after the time machine engine has been activated. The time machine interface 800 here includes a presentation window 801, a timeline 802, and function buttons. In this example, the time machine interface has been initiated for a music file management program, namely the iTunes™ application available from Apple Computer in Cupertino, Calif. Particularly, contents within this application such as music files, libraries, or playlists can be subject to back up operations and pruning.

As shown, the presentation window 801 is displaying the current state of the iTunes™ application because a “current” snapshot 804 has been selected (highlighted) in the timeline. As used herein, a snapshot refers to a backup element stored in an archive that includes a backup of selected items or content as specified by the backup component 117. The current snapshot can be a default selection. The presentation window 801 can show the contents corresponding to the currently selected archived view, or a portion thereof. In this particular example, there is presented a date beneath each snapshot indicating when the snapshot was taken. Here, each snapshot visible within the timeline 802 is a week apart from its neighbors.

In some implementations, the user can select items or content within the snapshots. For example, the user can select the snapshot 804, and next select one or more songs to back up using the time machine interface 800. In addition, the same selection functionality can be used in previous snapshots, such as snapshot 814, to restore missing data to the state associated with the current snapshot 804.

The timeline 802 can include a number of snapshots representing earlier versions or states of the iTunes™ library that have been backed up. Each snapshot provides a screenshot representation of the earlier version of the iTunes™ library at a particular point in time. In some implementations, the timeline 802 includes a visual representation of backup elements, such as a miniature version of the earlier state. The timeline can appear across the top portion of the time machine interface 802 (as shown). Alternatively, the timeline might not appear in the top portion of the time machine interface 800 until a user moves their cursor to (or otherwise activates) the timeline (e.g., by activating the top portion of the interface). It will be described below how a pruning (or deletion) operation can remove one or more of the snapshots from the timeline 802.

The time machine user interface 800 also includes function controls. For example, the interface 800 includes arrow buttons 806a and 806b to navigate the snapshots forward or backward. Arrow buttons 808a and 808b allow the user to navigate to additional snapshots not shown in the current timeline window, thus there can be a large number of snapshots from which to select.

The interface includes a restore all button 810 that, when selected, restores the view to the selected state represented by the selected snapshot. In some implementations, this terminates the session of the time machine. A user can select one element in a snapshot and then select the restore button 810 to modify the current version of the element selected (e.g., restore the state of the view). For example, in iTunes™, the user can select a few songs to restore, and this can trigger the restore button to display a more precise message, such as “restore selection only.”

An information button 816 provides information regarding the selected snapshot. In one implementation, selecting the information button 816 opens a panel display. The panel display can provide information including the date and time the snapshot was made, the location of actual contents in a snapshot, the size of the snapshot, and a comment section, to name a few examples. A close button 822 can be selected to exit the time machine. In some implementations, the time machine engine can automatically close upon a particular snapshot being restored. In some implementations, the user can minimize the time machine for purposes of navigating to other applications, such as an email application or a web browser.

In this example, the timeline 802 currently includes five snapshots: the current snapshot at the far right, and snapshots dated January 30, January 23, January 16 and January 9 extending to the left. It is seen that the snapshots have been taken at weekly intervals. Assume now that a pruning (or other deletion) operation is performed that reduces the frequency of backup operations to a semi-weekly basis. For example, this is done by the archive management module 226 (FIG. 2).

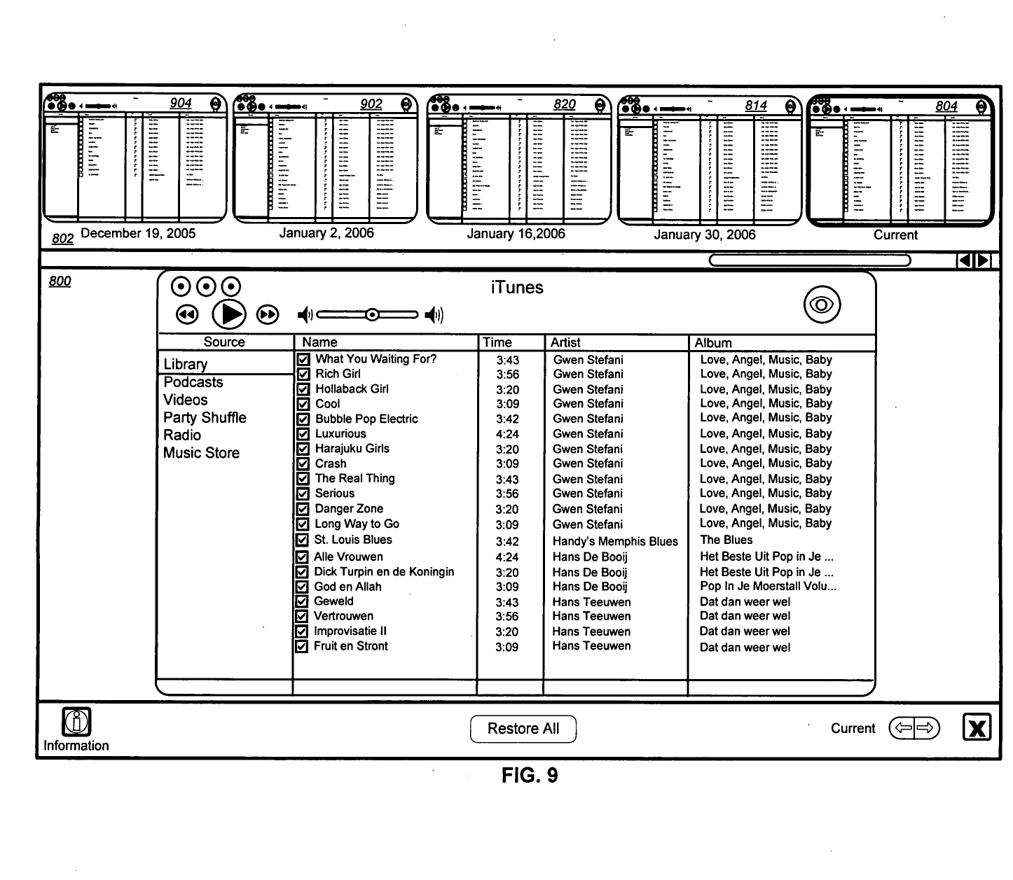

FIG. 9 is a screen shot depicting the time machine user interface 800 after the pruning (or deletion) operation has been performed. The timeline 802 no longer contains weekly data archives. Some snapshots have been deleted, resulting in the retention of a semi-weekly archival rate. Particularly, the January 23 and January 2 snapshots no longer appear in the timeline. In one implementation, this occurs due to the user setting a semi-weekly retention rate for the archive data of this timeframe. An earlier snapshot 902, dated “Jan. 2, 2006” and another previous snapshot 904 dated “Dec. 19, 2005” are now visible in the timeline 802, along with a first snapshot 814 and a second snapshot 820 that were also visible before the pruning. The pruning operation can be useful in freeing up memory space, or to make some snapshots (e.g., the older ones in this example) more accessible to the user by being visible in the timeline.

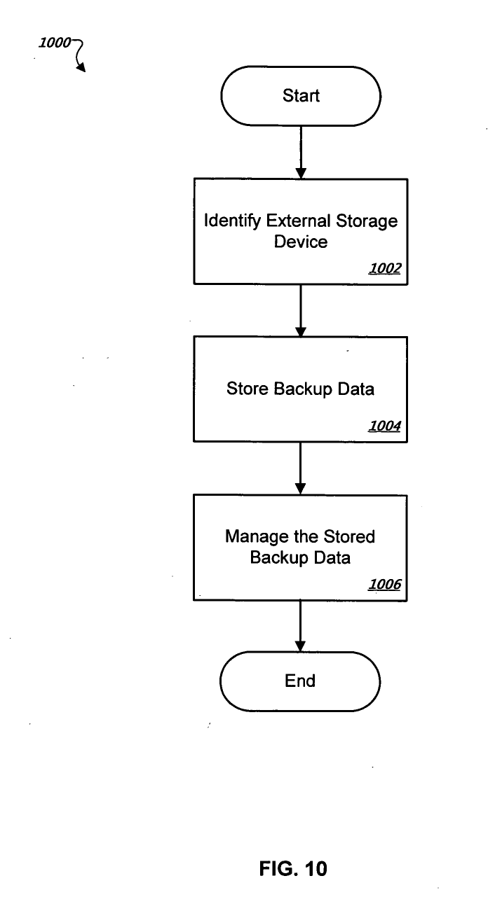

FIG. 10 is a flow diagram of a method 1000 illustrating an archival management scenario. The method 1000 can be performed in a computer system with a storage device, to name one example. Step 1002 identifies one or more external storage devices accessible by the system. A user can be alerted to select one or more storage devices to be used by the backup component 117. In one implementation, the user is presented with a graphical user interface to specify device settings (see FIG. 4). In one implementation, a single storage device is selected as the primary archival repository.

During storage of backup data (step 1004), a copy of user data can be captured and written, for example to the external storage device previously identified (step 1002). In one implementation, the copy of user data is stored in a standard file system hierarchy format. If previously captured backup data exists, an incremental archived view can be stored. In one implementation, the incremental archived view contains copies of changed data only, and unchanged data elements are stored as a link to the previously captured data element. In one implementation, the backup data is stored to an internal storage device if no external storage device is currently available or initialized for use.

A variety of events can trigger backup data storage (step 1004). In one implementation, a user can trigger the immediate capture of backup data, e.g., using the backup now button 316 within the time machine dialog window (FIG. 3). In another implementation, a user can establish a periodic backup schedule. As another example, a backup operation can be set to occur whenever there is a change within a specific data-set or whenever a particular event occurs, i.e. upon system start-up. In another implementation, the backup operation can be programmatically driven, dynamically driven, rule defined, or based on some other criteria.

Once a backup set of data exists, the stored backup data is managed (step 1006). The archive management can handle the removal of incremental archives to free storage space within the archive storage device(s). In one implementation, the user selects options regarding which data is to be removed and when. For example, this is controlled through a graphical user interface (see FIG. 6). A variety of options can exist for deleting archive data, e.g., archived views which do not contain any changed information can be deleted, the oldest information stored can be deleted, or the frequency of the archived views can be thinned the older they are, etc. Archive management methods can be applied to a certain device, a certain application or set of applications, a certain user, or they can be applied system-wide. In another implementation, archive data can be kept for a specified minimum time period. Alternatively, the archive data can be maintained for as long as a threshold amount of storage space is available.

In the above description, for purposes of explanation, numerous specific details are set forth in order to provide a thorough understanding. It will be apparent, however, to one skilled in the art that implementations can be practiced without these specific details. In other instances, structures and devices are shown in block diagram form in order to avoid obscuring the disclosure.

In particular, one skilled in the art will recognize that other architectures and graphics environments can be used, and that the examples can be implemented using graphics tools and products other than those described above. In particular, the client/server approach is merely one example of an architecture for providing the functionality described herein; one skilled in the art will recognize that other, non-client/server approaches can also be used. Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

An apparatus for performing the operations herein can be specially constructed for the required purposes, or it can comprise a general-purpose computer selectively activated or reconfigured by a computer program stored in the computer. Such a computer program can be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and modules presented herein are not inherently related to any particular computer or other apparatus. Various general-purpose systems can be used with programs in accordance with the teachings herein, or it could prove convenient to construct more specialized apparatuses to perform the method steps. The required structure for a variety of these systems will appear from the description. In addition, the present examples are not described with reference to any particular programming language. It will be appreciated that a variety of programming languages can be used to implement the teachings as described herein. Furthermore, as will be apparent to one of ordinary skill in the relevant art, the modules, features, attributes, methodologies, and other aspects can be implemented as software, hardware, firmware or any combination of the three. Of course, wherever a component is implemented as software, the component can be implemented as a standalone program, as part of a larger program, as a plurality of separate programs, as a statically or dynamically linked library, as a kernel loadable module, as a device driver, and/or in every and any other way known now or in the future to those of skill in the art of computer programming. Additionally, the present description is in no way limited to implementation in any specific operating system or environment.

The subject matter described in this specification can be implemented as one or more computer program products, i.e., one or more modules of computer program instructions encoded on a computer readable medium for execution by, or to control the operation of, data processing apparatus. The instructions can be organized into modules (or engines) in different numbers and combinations from the exemplary modules described. The computer readable medium can be a machine-readable storage device, a machine-readable storage substrate, a memory device, a composition of matter effecting a machine-readable propagated signal, or a combination of one or more them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

While this specification contains many specifics, these should not be construed as limitations on the scope of what may be claimed, but rather as descriptions of features specific to particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

The subject matter of this specification has been described in terms of particular embodiments, but other embodiments can be implemented and are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous. Other variations are within the scope of the following claims.

What is claimed is:

1. A method comprising:
automatically identifying an external storage device coupled to a computer system for use in storing backup data;
storing backup data for the system on the identified storage device, the stored backup data including a file system hierarchy; and
managing the stored backup data.

2. The method of claim 1, where identifying a storage device includes receiving a user input selecting a particular storage device.

3. The method of claim 1, further comprising:
storing incremental backup data on the storage device, the incremental backup data including data representing changes from the stored backup data.

4. The method of claim 1, where storing backup data includes uploading data to server storage device.

5. The method of claim 1, where managing the stored backup data includes removing previously stored backup data.

6. The method of claim 5, where removing previously stored backup data includes removing backup data according to a date on which the previously stored backup data was stored.

7. The method of claim 5, where removing previously stored backup data includes removing backup data according to a threshold capacity of the external storage device.

8. The method of claim 5, where removing previously stored backup data includes using one or more criteria to determine which data of the stored backup data to delete, where the criteria maximize storage and minimize data loss.

9. A method comprising:
identifying a first external storage device coupled to a computer system for use in storing backup data;
identifying a second external storage device coupled to the computer system for use in storing backup data;
storing backup data for the system to one or more of the first and second external storage devices, the stored backup data including a file system hierarchy; and
managing the stored backup data.

10. The method of claim 9, where storing backup data for the system includes storing backup data alternatively between the first external storage device and the second external storage device.

11. The method of claim 9, further comprising:
automatically switching from the first external storage device to the second external storage device when a threshold capacity of the first external storage device is reached.

12. The method of claim 9, further comprising:
storing identical backup data on the first external storage device and the second external storage device.

13. A system comprising:
means for automatically identifying an external storage device coupled to a computer system for use in storing backup data;
means for storing backup data for the system on the identified storage device, the stored backup data including a file system hierarchy; and
means for managing the stored backup data.

14. A system comprising:
means for identifying a first external storage device coupled to a computer system for use in storing backup data;
means for identifying a second external storage device coupled to the computer system for use in storing backup data;
means for storing backup data for the system to one or more of the first and second external storage devices, the stored backup data including a file system hierarchy; and
means for managing the stored backup data.

15. A method comprising:
defining one or more criteria for capturing a state of a view of a user interface;
capturing the state of the view in accordance with the criteria;
storing a captured view on an external storage device;
receiving a prompt to suspend presentation of a current view and present the captured view;
retrieving the captured view from the external storage device; and
reinstating the captured view into the current view of the user interface.
